(19) United States
(12) Patent Application Publication
(10) Pub. No.: US 2019/0324548 A1
(43) Pub. Date: Oct. 24, 2019

(54) GESTURE-BASED DESIGNATION OF REGIONS OF INTEREST IN IMAGES

(71) Applicant: JG Management Pty. Ltd., Victoria (AU)

(72) Inventor: Juan Garcia, Victoria (AU)

(73) Assignee: JG Management Pty. Ltd., Victoria (AU)

(21) Appl. No.: 15/956,365

(22) Filed: Apr. 18, 2018

(51) Int. Cl. G06F 3/01; G06F 3/0482; G06F 3/0488; G06K 9/00; G06K 9/32

(52) U.S. Cl. CPC G06F 3/017; G06F 3/013; G06K 9/3233; G06F 3/04883; G06K 9/00335; G06F 3/0482

(57) ABSTRACT

Systems and methods are provided for gesture-based designation of regions of interest within images displayed on handheld devices. Designation of a region of interest may lead to further processing, e.g., related to the image content within the region of interest. For example, the user may use a gesture to delimit a region of interest of an image, and the region of interest may be provided to an automated image-recognition system. For another example, a user may use a gesture to delimit a region of interest of a map and may be provided with information about one or more points of interest within the delimited region.

### BACKGROUND

Automated techniques are known for identifying an object in a photograph or other image. An exemplary disclosure is found in U.S. Pat. No. 9,489,401, titled “Methods and Systems for Object Recognition”, which is incorporated herein by reference. But such techniques face challenges, including problems caused by images that include distracting details (or “noise”) and multiple objects.

This challenge can be illustrated by considering FIG. 1, which is a line drawing that represents a photograph that may be provided to an object recognition system. FIG. 1 depicts a table set with, e.g., plates, cups, and utensils. Given such a photograph as input, an image recognition system may identify the contents of the photograph as, e.g., a “breakfast table”. But the object of interest may be, e.g., one of the plates, cups, or utensils on the table rather than the table itself.

An additional consideration is that object recognition may be done, e.g., using a portable, handheld device, such as a smartphone or tablet. Object recognition may be particularly helpful to a user of such a device who wishes, e.g., to learn more about an object or location connected with the user's travel. Although handheld devices may commonly include cameras and other means (e.g., network connections) to acquire images, the touchscreen interface may complicate the user's manipulation of the image, including manipulation meant to improve automated recognition of content related to the image.

For these reasons, there is needed, in connection with automated recognition of content associated with images, an improved way to isolate a portion of a source image that includes content of particular interest. There is further need for such techniques that are practical and convenient when used in connection with handheld electronic devices. And there is a further need for corresponding techniques applicable to other new technologies, such as augmented reality systems.

### BRIEF SUMMARY OF THE INVENTION

Embodiments of the invention relate to systems and methods for gesture-based designation of regions of interest within images displayed on handheld devices. Designation of a region of interest may lead to further processing, e.g., related to the image content within the region of interest. For example, in an embodiment of the invention, the user may use a gesture to delimit a region of interest of an image, and the region of interest may be provided to an automated image-recognition system. In another embodiment of the invention, a user may use a gesture to delimit a region of interest of a map and may be provided with information about one or more points of interest within the delimited region.

According to an embodiment of the invention, a method of improving automated content identification uses a computing device that comprises one or more processors, a memory coupled to at least one of the processors, an image acquisition means, an input device, and a display, and the computing device is configured to communicate via one or more data networks. The method comprises acquiring an image comprising a plurality of identification points via the image acquisition means and storing in the memory first data comprising the image; accepting input through the input device; identifying a gesture using the input; using the gesture to produce second data, the second data delimiting a region of the image, a first at least one of the identification points being in the region and a second at least one of the identification points being outside of the region; automatically identifying one or more entities based on the first at least one of the identification points; and displaying information on the device's display related to one or more of the identified entities.

According to an embodiment of the invention, a method of improving automated content identification uses a portable device comprising one or more processors, a memory coupled to at least one of the processors, and a touchscreen comprising a display and coupled to one or more of the processors, and the portable device is configured to communicate via one or more data networks. The method comprises storing in the memory first data comprising an image comprising a plurality of identification points; displaying the image on the device's display; accepting user input through the touchscreen to produce second data, the second data delimiting a region of the image, a first at least one of the identification points being in the region and a second at least one of the identification points being outside of the region; automatically identifying one or more entities based on the first at least one of the identification points; and displaying information on the device's display related to one or more of the identified entities.

In an embodiment of the invention, the method comprises displaying on the device's display, contemporaneously with the information related to one or more of the identified entities, the region of the image delimited by the second data.

In an embodiment of the invention, automatically identifying one or more entities based on the first at least one of the identification points comprises automatically identifying a set of identification points based on the first data and the second data, the set of identification points comprising all of the first at least one of the identification points and excluding all of the second at least one of the identification points.

Alternatively, in an embodiment of the invention, automatically identifying one or more entities based on the first at least one of the identification points comprises computing third data based on the first data and the second data; transmitting the third data to the server via the network; and receiving information, from the server via the network, that identifies the one or more entities.

Alternatively, in an embodiment of the invention, the user input consists of one or more touchscreen gestures. Further, in an embodiment of the invention, the user input consists of one touchscreen gesture, and automatically identifying one or more entities based on the first at least one of the identification points occurs immediately consequent to completion of the one touchscreen gesture. Alternatively, in an embodiment of the invention, the user input consists of one touchscreen gesture, and automatically identifying one or more entities based on the set of identification points occurs immediately consequent to completion of exactly one additional touchscreen gesture performed immediately subsequent to the one touchscreen gesture.

Alternatively, in a further embodiment of the invention, the touchscreen gesture is a single-touch gesture by which the user draws one or more lines on the image. In an embodiment of the invention, the second data delimits a region having the shape of a closed polygon. In still a further embodiment of the invention: the closed polygon is a rectangle; the rectangle has two vertical edges; and no rectangle smaller than the rectangle encloses all of the one or more lines. In an embodiment of the invention, the image is a photograph. According to still a further embodiment of the invention, displaying of the information on the device's display related to one or more of the identified entities comprises displaying information that identifies exactly one object that the photograph depicts.

Alternatively, in an embodiment of the invention, the polygon is irregular. Further, in an embodiment of the invention, the image is a map depicting a geographic area, and each identification point is a respective location on the map. In an embodiment of the invention, each identification point is associated with a respective point of interest in the geographic area; and each identified entity is the point of interest associated with a respective one of the first at least one of the identification points.

Further, in an embodiment of the invention, displaying information related to one or more of the identified entities comprises displaying a list comprising one or more entries, each entry comprising text identifying the point of interest associated with the identification point associated with the entity. In an embodiment of the invention, displaying information related to one or more of the identified entities comprises displaying on the map or on a portion of the map one or more symbols; and each symbol has a placement on the displayed map or portion of the map corresponding to a respective identification point associated with a respective entity.

According to an embodiment of the invention, a method of improving automated content identification within a view uses a portable device comprising one or more processors, a memory coupled to at least one of the processors, an electronic display device, a view-acquisition camera coupled to at least one of the processors and disposed to acquire an image corresponding to the view, and an eye-tracking camera coupled to at least one of the processors and disposed to track an eye of a user of a device as the user looks at the view. The method comprises acquiring a view image via the view acquisition camera, the view image comprising a plurality of identification points; acquiring eye-tracking data via the eye-tracking camera; receiving activation input; and, consequent to receiving the activation input, using the eye-tracking data to determine that the user has made a first eye gesture. The method further comprises identifying a region of interest of the view based on the first eye gesture; identifying an image region of interest within the view image that corresponds to the region of interest of the view, a first at least one of the identification points being in the image region of interest and a second at least one of the identification points being outside of the image region of interest; automatically identifying one or more entities based on the first at least one of the identification points; and displaying information via the electronic display device related to one or more of the identified entities.

In an embodiment of the invention, the method comprises, consequent to identifying the region of interest of the view, displaying information on the electronic display device to superimpose on the view information that indicates the region of interest.

In an embodiment of the invention, the activation input is a second eye gesture that is not the first eye gesture. Alternatively, in an embodiment of the invention, the portable device comprises a microphone coupled to one or more of the processors, and the activation input is a voice command received via the microphone.

In an embodiment of the invention, the electronic display device is a projector; the user's looking at the view comprises looking directly at the objects in the view; and the displaying information on the electronic display device to superimpose on the view information that indicates the region of interest comprises the projector projecting the information.

Alternatively, in an embodiment of the invention, the electronic display device is a video screen; the portable device comprises an image-acquisition camera distinct from the eye-tracking camera; the user's looking at the view comprises looking at an image displayed by the video screen, the portable device acquiring the image via the image-acquisition camera; and the displaying information on the electronic display device to superimpose on the view information that indicates the region of interest comprises modifying the image displayed on the video screen. In a further embodiment of the invention, the method comprises continuously updating the image in real time based on input provided by the image-acquisition camera.

According to an embodiment of the invention, a method of improving automated content identification within a view using a portable device comprising one or more processors, a memory coupled to at least one of the processors, an electronic display device, and a camera coupled to at least one of the processors and disposed to acquire an image corresponding to the view. The method comprises acquiring a view image via the camera, the view image comprising a plurality of identification points; acquiring hand-tracking data via the camera; receiving activation input; and consequent to receiving the activation input, using the hand-tracking data to determine that the user has made a first human body gesture. The method further comprises identifying the region of interest of the view based on the first human body gesture; identifying an image region of interest within the view image that corresponds to the region of interest of the view, a first at least one of the identification points being in the image region of interest and a second at least one of the identification points being outside of the image region of interest; automatically identifying one or more entities based on the first at least one of the identification points; and displaying information via the electronic display device related to one or more of the identified entities.

In an embodiment of the invention, the method comprises, consequent to identifying the region of interest of the view, displaying information on the electronic display device to superimpose on the view information that indicates the region of interest.

In an embodiment of the invention, the activation input is a second human body gesture that is not the first human body gesture. Alternatively, in an embodiment of the invention, the portable device comprises a microphone coupled to one or more of the processors; and the activation input is a voice command received via the microphone.

In an embodiment of the invention, the electronic display device is a projector; the user's looking at the view comprises looking directly at the objects in the view; and the displaying information on the electronic display device to superimpose on the view information that indicates the region of interest comprises the projector projecting the information.

### BRIEF DESCRIPTION OF THE DRAWINGS

The present invention will be understood more fully with reference to the drawings. The drawings are provided for the purpose of illustration and are not intended to limit the invention.

FIG. 1 is a line drawing that corresponds to an example of an image that could be input to an object-recognition system.

FIG. 2 depicts functional components of a representative handheld device.

FIG. 3 depicts elements of interconnected wired and wireless data networks.

FIG. 4 depicts a flow of object isolation and recognition according to embodiments of the invention.

FIG. 5 depicts a user interface display of an app on a handheld device according to an embodiment of the invention.

FIG. 6 depicts a flow of capturing coordinates from a user input touchscreen gesture according to an embodiment of the invention.

FIG. 7 depicts a user interface display of an app on a handheld device according to an embodiment of the invention.

FIG. 8 depicts a user interface display of an app on a handheld device according to an embodiment of the invention.

FIG. 9 depicts a flow of automated recognition of content of an image in connection with an embodiment of the invention.

FIG. 10 depicts a flow of automated recognition of content of an image in connection with an embodiment of the invention.

FIG. 11 depicts a flow of automated recognition of content of an image in connection with an embodiment of the invention.

FIG. 12 depicts a flow of automated recognition of content of an image in connection with an embodiment of the invention.

FIG. 13 depicts a user interface display of an app on a handheld device according to an embodiment of the invention.

FIG. 14 depicts a flow of map filtering according to an embodiment of the invention.

FIG. 15 depicts a user interface display of an app on a handheld device according to an embodiment of the invention.

FIG. 16 depicts a user interface display of an app on a handheld device according to an embodiment of the invention.

FIG. 17 depicts a user interface display of an app on a handheld device according to an embodiment of the invention.

FIG. 18 depicts augmented reality glasses being worn, e.g., in connection with an embodiment of the invention.

FIG. 19 depicts an example of image superposition as in augmented reality glasses in connection with an embodiment of the invention.

FIG. 20 depicts an augmented reality application on a smartphone permitting selection of an area of interest within an image according to an embodiment of the invention.

FIG. 21 depicts a flow of object isolation and recognition according to an embodiment of the invention.

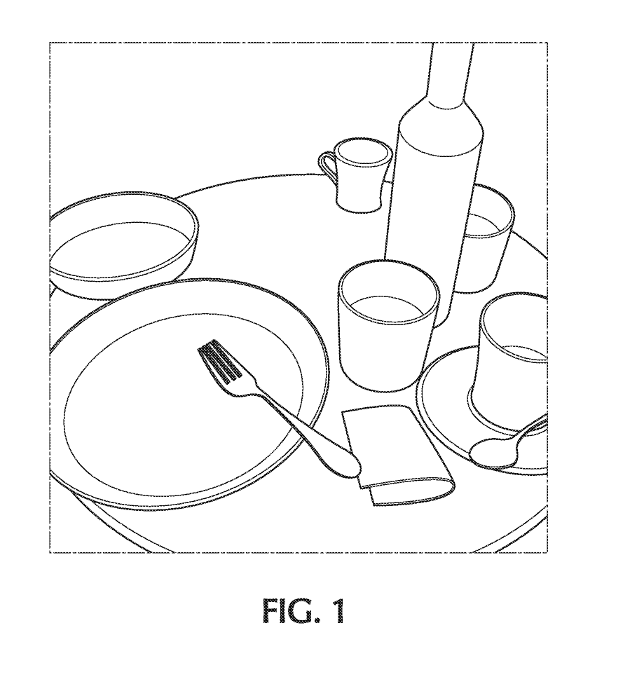

### DETAILED DESCRIPTION OF PREFERRED EMBODIMENTS

Embodiments of the invention relate to isolating regions within digital images and automatically identifying contents of the regions. Embodiments may use or include, e.g., handheld devices such as smartphones and tablets, and these devices may, e.g., participate in one or more computer networks.

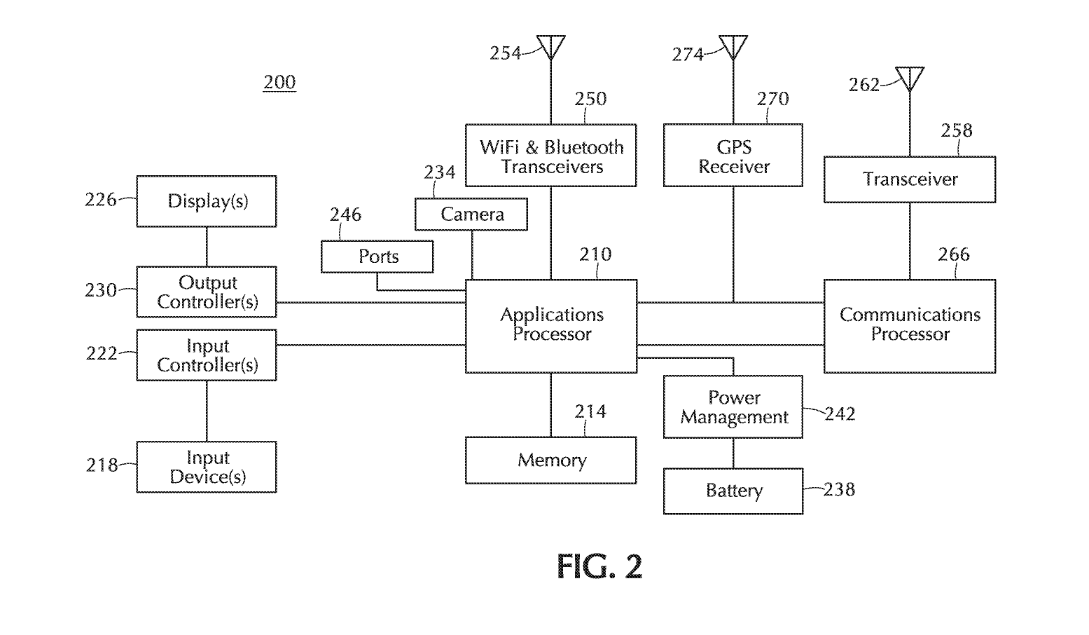

FIG. 2 is a simplified block diagram that illustrates functional components that may be found in a handheld device 200, in connection with an embodiment of the invention. Functions in a handheld device may be controlled, e.g., by a programmable applications processor or microcontroller 210. Memory 214 coupled to the applications processor 210 may include one or more kinds of persistent and/or volatile memory and may store, e.g., instructions to be executed by the applications processor 210 and/or data upon which the applications processor 210 may operate, which may represent, e.g., one or more operating systems, programs, and/or other functions and/or data, among other things.

One or more input devices 218 may be coupled to the applications processor 210, e.g., directly and/or via one or more input controllers 222. Examples of input devices 218 may include, among other possibilities, one or more buttons and/or switches (which may include buttons or switches configured as one or more keypads and/or keyboards), touchscreens, proximity sensors, accelerometers, and/or photosensors.

One or more output devices, including, e.g., one or more displays 226, may be coupled to the applications processor 210, e.g., directly and/or via one or more output controllers 230. A handheld device 200 may output information in ways that do not involve a display 226, e.g., by controlling illumination of one or more LEDs or other devices.

In a handheld device 200, which may be, e.g., a device capable of acting as a telephone, the input devices 218 and output devices 226 may include devices configured to detect and/or emit sound (not pictured).

A handheld device 200 may comprise one or more cameras 234 capable of recording, e.g., still and/or moving pictures. As depicted, the camera 234 may be coupled to the applications processor 210.

FIG. 2 depicts a handheld device 200 that includes only one camera 234, but these devices commonly may include two or more cameras. For example, a smartphone may have a front-facing camera that faces the user as the user looks at the screen and a rear-facing camera that faces away from the user.

The handheld device 200 may be powered, e.g., by one or more batteries 238. The applications processor 210 and/or other components may be powered, e.g., via a power management unit 242 coupled to the battery 238. If the battery 238 is rechargeable, the power management unit 242 may monitor and/or control charging and/or discharging of the battery 238. Power to charge the battery 238 may be supplied, e.g., via one or more external ports 246.

A handheld device 200 may include one or more external ports 246 that may support analog and/or digital input and/or output.

A handheld device 200 may be configured to participate in one or more local area networks (LANs). For example, as FIG. 2 depicts, a handheld device 200 may include one or more transceivers 250 supporting, e.g., Bluetooth® and/or Wi-Fi™ networking. Such a transceiver 250 may be connected, e.g., to one or more antennas 254 and, as FIG. 2 depicts, may be coupled to the applications processor 210.

A handheld device 200 may be configured to interact with one or more wide-area networks (WANs), such as, e.g., cellular voice and/or data networks. For example, as FIG. 2 depicts, a handheld device may comprise one or more cellular transceivers 258 and associated antennas 262. A transceiver 258, as in the depicted device 200, may be coupled to a device such as a communications processor 266, which may include functions such as, for example, of a digital signal processor and/or a microcontroller. A communications processor 266 in a handheld device 200 may also be coupled directly or indirectly to the applications processor 210.

A handheld device 200 may include a unit 270 that is capable of receiving and/or interpreting signals from the Global Positioning System (GPS). The GPS receiver 270 may be coupled to its own antenna 274. The GPS receiver may also be coupled in a handheld device 200 to the applications processor 210, the communications processor 266, or both.

It will be appreciated that FIG. 2 and the associated discussion are not meant to describe precisely any particular device but rather to illustrate functions that may commonly be found in certain classes of devices. A handheld device suitable for use in connection with an embodiment of the invention may differ in its physical or logical organization from the depicted device, and such a device may comprise one or more other components in addition to, or instead of, any one or more discussed or depicted components.

As mentioned, a handheld device 200 may accept input through a touchscreen, e.g., by a user's bringing one or more fingers into contact with the surface of the screen in a certain way. “Gesture” is a term that may be used in a broad sense to refer to a movement of one or more body parts to provide input to a computing device. It generally refers to forms of input that involve detecting the locations, movements, or both, of the body part or parts at one or more times and interpreting that information to produce the input. But it specifically excludes input in the form, e.g., of a user's pressing a mechanical button, a key on a keyboard, and similar kinds of input.

“Gesture” may also be used more narrowly in connection with user interfaces for touchscreen devices and may refer in that context to a combination of finger movements in relation to the screen that the software—at the operating system level, the application level, or a combination of the two—recognizes as a single event and responds to as such. Examples of common gestures are tap, double-tap, long press, scroll, pan, flick, two-finger tap, two-finger scroll, pinch, zoom, and rotate; other gestures are also known and widely used. A gesture in which only one finger touches the screen may be referred to as a “one-finger gesture” or a “single-touch gesture”. For clarity, this disclosure primarily (but not exclusively) uses the term “touchscreen gesture” when “gesture” is used in this sense; for brevity, “touchscreen” is sometimes omitted, but the applicable meaning of “gesture” will be clear from context.

(These definitions of “gesture” and “touchscreen gesture” are provided for identification and the reader's convenience but not to give any term a non-standard meaning. To the contrary, unless explicitly indicated otherwise or required by context, “gesture” and “touchscreen gesture” in this disclosure should be taken to have the ordinary and customary meanings given to the terms by those of ordinary skill in the art.)

A handheld device may be capable of storing and/or executing one or more application programs (or “applications”). In an embodiment of the invention, an application may, e.g., display an image, process it, and compute or retrieve information related to its contents. For example, in an embodiment of the invention, the application may display, e.g., a photograph or other image, accept input from the user to delimit a region of the image, and use information from the image in identifying an object depicted within the region. Alternatively, in an embodiment of the invention, the application may accept user input to delimit a region of the displayed map and then display information, e.g., about one or more objects or places of interest within the area that the delimited region of the map depicts. In either case, the user input may be made in the form of, or may include, one or more touchscreen gestures.

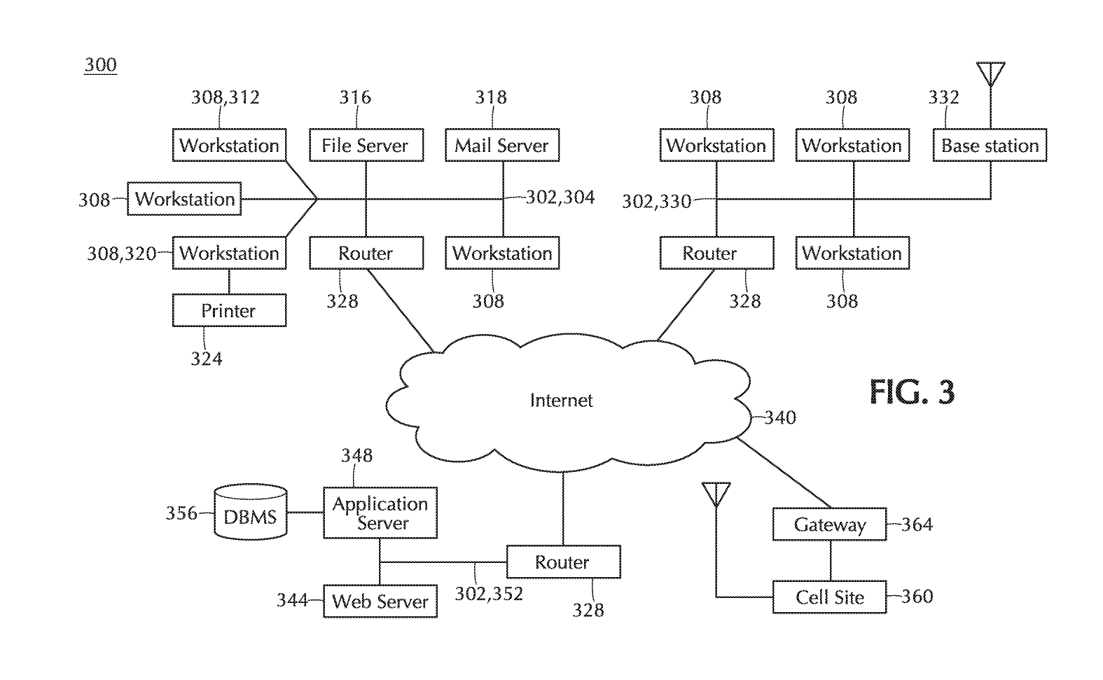

FIG. 3 depicts elements of wired and wireless networks 302 such as, e.g., one or more computers, handheld devices, or both, may use to communicate in connection with an embodiment of the invention. A network 304 may, for example, connect one or more workstations 308 with each other and with other computer systems, such as file servers 316 or mail servers 318. The connection may be achieved tangibly, e.g., via optical cables, or wirelessly.

A network 302 may enable a computer system to provide services to other computer systems, consume services provided by other computer systems, or both. For example, a file server 316 may provide common storage of files for one or more of the workstations 308 on a network 304. A workstation 312 may send data including a request for a file to the file server 316 via the network 304 and the file server 316 may respond by sending the data from the file back to the requesting workstation 312.

The terms “workstation,” “client,” and “server” may be used herein to describe a computer's function in a particular context, but any particular workstation may be indistinguishable in its hardware, configuration, operating system, and/or other software from a client, server, or both. Further, a computer system may simultaneously act as a workstation, a server, and/or a client. For example, as depicted in FIG. 3, a workstation 320 is connected to a printer 324. That workstation 320 may allow users of other workstations on the network 304 to use the printer 324, thereby acting as a print server. At the same time, however, a user may be working at the workstation 320 on a document that is stored on the file server 316.

The terms “client” and “server” may describe programs and running processes instead of or in addition to computer systems such as described above. Generally, a (software) client may consume information and/or computational services provided by a (software) server.

A network 304 may be connected to one or more other networks 302, e.g., via a router 328. A router 328 may also act as a firewall, monitoring and/or restricting the flow of data to and/or from a network 302 as configured to protect the network. A firewall may alternatively be a separate device (not pictured) from the router 328.

Connections within and between one or more networks may be wired or wireless. For example, a computer or handheld device may participate in a LAN using one or more of the standards denoted by the term Wi-Fi™ or other technology. Wireless connections to a network 330 may be achieved through use of, e.g., a device 332 that may be referred to as a “base station”, “gateway”, or “bridge”, among other terms.

A network 300 of networks 302 may be referred to as an internet. The term “the Internet” 340 refers to the worldwide network of interconnected, packet-switched data networks that uses the Internet Protocol (IP) to route and transfer data. A client and server on different networks may communicate via the Internet 340. For example, a workstation 312 may request a World Wide Web document from a Web Server 344. The Web Server 344 may process the request and pass it to, e.g., an Application Server 348. The Application Server 348 may then conduct further processing, which may include, for example, sending data to and/or receiving data from one or more other data sources. Such a data source may include, e.g., other servers on the same network 352 or a different one and/or a Database Management System (“DBMS”) 356.

Depending on the configuration, a computer system such as the application server 348 in FIG. 3 or one or more of its processors may be considered to be coupled, e.g., to the DBMS 356. In addition to or instead of one or more external databases and/or DBMSs, a computer system may incorporate one or more databases, which may also be considered to be coupled to one or more of the processors within the computer system.

Devices, including, e.g., suitably configured handheld devices and computers, may communicate with Internet-connected hosts. In such a connection, the device may communicate wirelessly, e.g., with a cell site 360 or other base station. The base station may then route data communication to and from the Internet 340, e.g., directly or indirectly through one or more gateways 364 and/or proxies (not pictured).

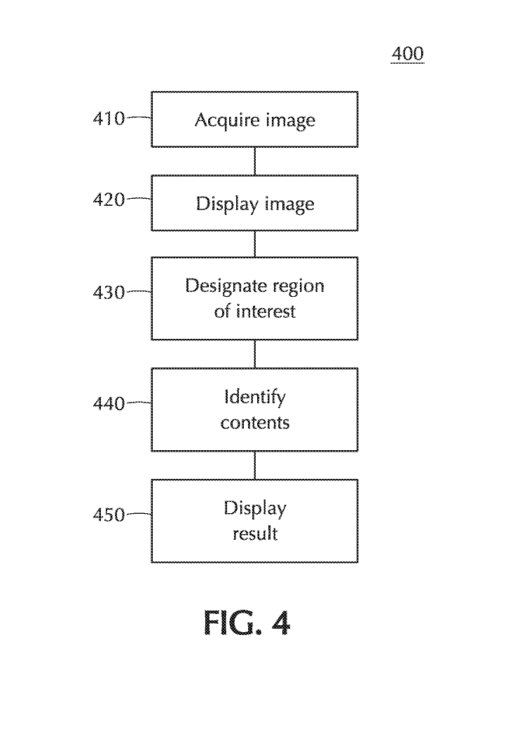

FIG. 4 depicts a flow 400 of object isolation and recognition according to an embodiment of the invention. The flow 400 begins with acquisition 410 of an image by a handheld device. In connection with embodiments of the invention, the image may be, e.g., a photograph stored as a file in JPEG or other format and may be, e.g., stored in persistent memory on the device. The photograph may acquired, e.g., through the device's camera 234 (FIG. 2) or from another device, e.g., via a network or other connection.

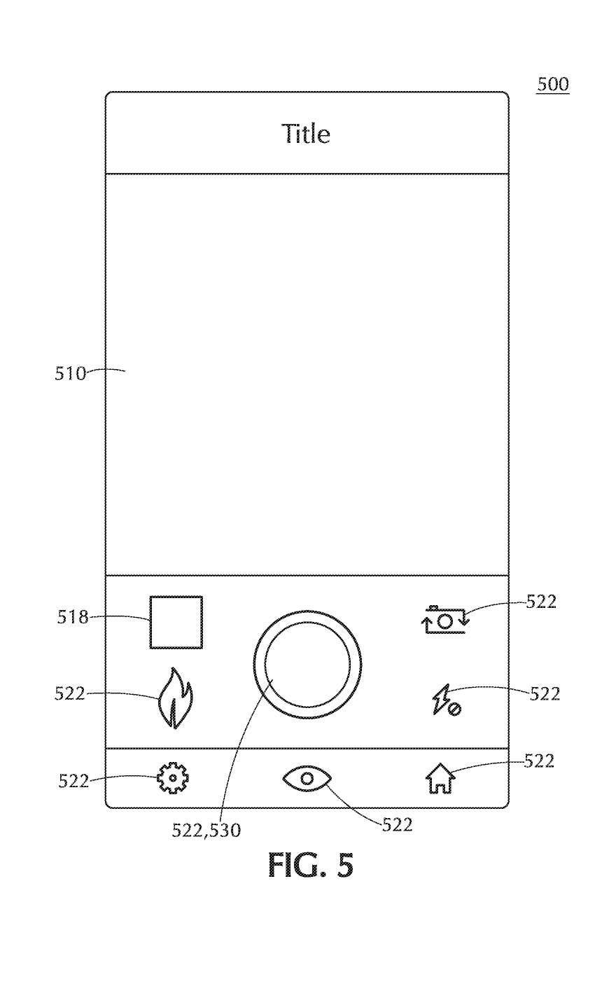

Returning to FIG. 4, block 420 represents displaying the image on the device. FIG. 5 depicts an example user interface display 500, including a region that may display an image 510, presented by an example app according to an embodiment of the invention. The display 500 may include, e.g., one or more controls that the user can interact with via one or more touchscreen gestures.

For example, as depicted, the display 500 includes controls allowing the user to change the image that the app is presenting. (In embodiments of the invention, the display 500 may be presented without an image 510, e.g., on activation of the app or the user's activation of this function within the app, and the controls may be used to provide, e.g., a photograph for initial display.) As depicted, an icon 530 allows the user to activate the device's camera to acquire a new image. Alternatively, another icon 518 allows the user to select a new image from a gallery (not pictured) of images, e.g., stored on the device and arranged in one or more albums. Other controls 522 may be provided and may, e.g., activate other functions of the app or otherwise provided by the device.

When an image 510 is displayed, e.g., as in FIG. 5, the user may submit the entire image for automated object recognition, e.g., by selecting the entire image 510. Alternatively, the user can designate a region of interest within the image 510, e.g., with one or more touchscreen gestures as described herein. Block 430 in FIG. 4 represents the user's designation of such a region according to an embodiment of the invention.

According to an embodiment of the invention, the user can designate a region of interest from the user interface display 500 of FIG. 5, e.g., by performing a touchscreen gesture that begins with touching the touchscreen in the region displaying the image 510. The user may in such an embodiment use a pan gesture to indicate the area of interest. In an embodiment of the invention, when the user touches and drags their finger on the screen, performing the pan gesture, the app may capture, e.g., one or more coordinate points (e.g., as x and y coordinates) from the screen. In capturing the coordinate points, the app may, e.g., take advantage of one or more facilities provided by the device's operating system.

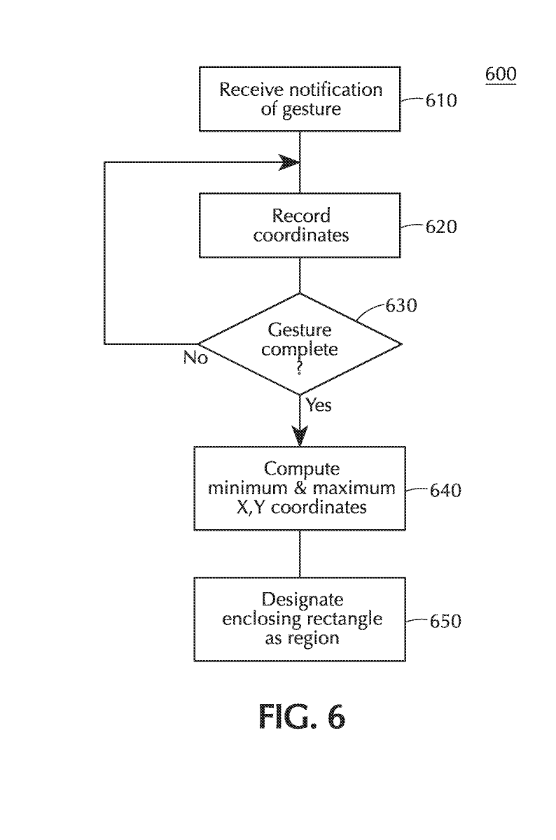

For example, FIG. 6 depicts an example flow 600 of capturing coordinates from a pan gesture according to an embodiment of the invention. The flow 600 begins in block 610, when an app receives a notification, e.g., from the device's operating system, that a gesture has begun within the area of the touchscreen that corresponds to the image. In block 620, the app records x- and y-coordinates associated with the event, e.g., in an array.

In an event-driven software architecture, the operating system may continue to provide notifications to the app, e.g., until the user completes the gesture. In block 630, the app receives notification of an event and determines whether the event means that the gesture has ended. If the gesture has not ended, the app may return to block 620 and record new x- and y-coordinates associated with the new event.

When the app determines that the gesture is complete, in an embodiment of the invention, it computes points corresponding to the minimum and maximum x- and y- coordinates in block 640, and, based on those points, defines a rectangle in block 650. The rectangle may then be used to define an area of interest within the image.

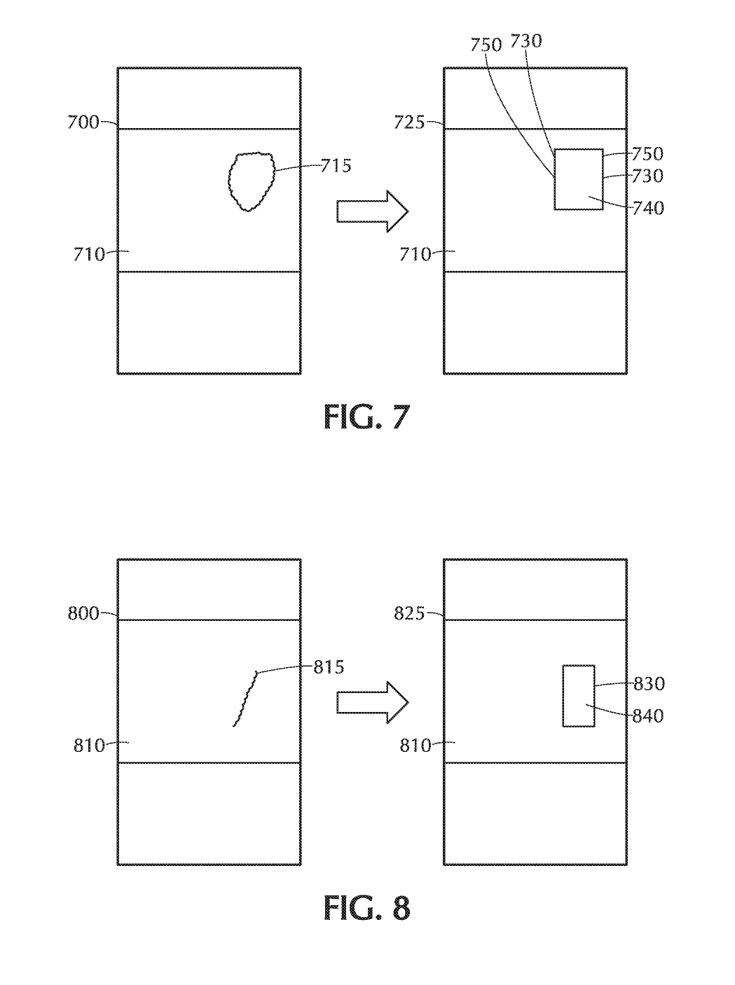

FIG. 7 depicts screens 700, 725 from a user interface display as a user provides input to delimit an area of interest, according to embodiments of the invention. On the display 700, the user may perform a pan gesture (not pictured) within the displayed image 710. The app may update the display 700 during the gesture to include, superimposed on the image 710, e.g., a line, open or closed curve, or other shape 715 that depicts the path of the user's finger in making the gesture, continuously updating the display as the user continues to perform the gesture. For example, FIG. 7 depicts the path of the user's finger as a closed curve 715, but other possibilities exist in connection with embodiments of the invention.

Once the touchscreen gesture to define a region of interest is completed, in an embodiment of the invention, the app may wait until the user provides additional input, e.g., selecting a control, to compute the enclosing rectangle 730 from the gesture. Alternatively, in embodiments of the invention, the app may compute the enclosing rectangle 730 immediately upon the user's completion of the touchscreen gesture, without requiring additional input. The app may provide an updated display 725 (FIG. 7), in which the path of the gesture 715 is replaced by the calculated enclosing rectangle 730. The portion of the image 710 within the enclosing rectangle 730 may be considered the region of interest 740.

In an embodiment such as FIG. 7 depicts, the device's screen may be rectangular, or essentially so, and the x and y coordinate axes may be parallel to respective edges of the screen. Depending on the orientation of the device, the screen may be considered to have a top, a bottom, and two side edges. One of the coordinate axes (which may be considered a vertical axis) may be essentially parallel to the side edges, running from top to bottom, and the other may be perpendicular to the first axis, running from one side edge to the other. In such an embodiment, two edges 750 of the enclosing rectangle 730 may be considered vertical in that they are parallel to the vertical axis.

In connection with an embodiment of the invention, a user's finger may trace, e.g., a line, rather than a closed curve 715 as FIG. 7 depicts. FIG. 8 depicts a user interface screen 800 showing an image 810 on which a user has made a pan gesture tracing an essentially straight line 815. Embodiments of the invention may use, e.g., the endpoints of the line 815 to define an enclosing rectangle 830 and a region of interest 840 within the rectangle 830.

In embodiments of the invention, after the user completes a gesture to define a region of interest, the app may wait until the user provides additional input, e.g., selecting a control, to compute the enclosing rectangle from the gesture. Alternatively, in embodiments of the invention, the app may compute the enclosing rectangle immediately upon the user's completion of the touchscreen gesture, without requiring additional input.

Once the region of interest has been defined, block 440 in FIG. 4 represents computerized identification of the contents of the image within the region of interest. In embodiments of the invention, this process may begin automatically (i.e., without additional user input specifically to begin this process) after the user defines the region of interest, e.g., by completing the touchscreen gesture or by providing input to accept the gesture's designation of the region of interest.

If the user does not wish to proceed with the selected region of interest, the user may in an embodiment of the invention select a control such as a “cancel button” 530 (FIG. 5), e.g., to discard the designation and permit designation of a new region of interest, or, in embodiments, to discard the acquired image (see FIG. 4, block 410) altogether.

In embodiments of the invention, the app may identify an object or objects in block 440 (FIG. 4) in conjunction with one or more servers, communicating with the server via one or more wired or wireless networks (or both). U.S. Pat. No. 9,489,401 teaches several methods of automated image recognition, which may operate in parallel, and which may refer to one or more contextual databases of image data.

According to embodiments of the invention, an app may generate image data based on the user's definition of a region of interest, send the image data to one or more of the servers, and then provide image recognition information to the user based on the response received from the server. The image data may take various forms, depending on the embodiment of the invention, including, e.g., a sub-image consisting of the portion of the image delimited by the user's touchscreen gesture, or the image and information describing the region of interest.

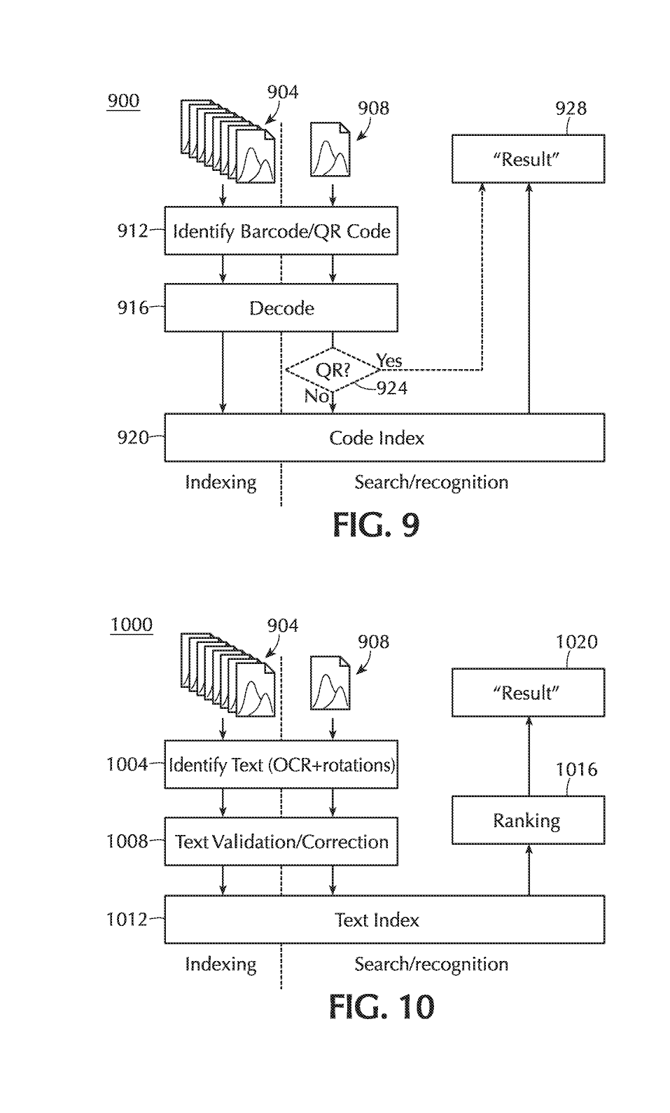

A server may process the image data using one or more indexing and search algorithms; exemplary algorithms are illustrated in the flow diagrams of FIGS. 9 to 12.

FIG. 9 shows a flow diagram 900 illustrating barcode/QR code indexing and search embodying the invention. In general, the various algorithms described in connection with embodiments of the invention follow similar patterns, although other image searching and object recognition techniques may be employed in alternative embodiments, and they need not necessarily follow this same pattern. Broadly speaking, however, images 904 identified and retrieved by content-specific Web crawlers are analyzed to extract “features” (which may be, e.g., non-image descriptors characterizing objects appearing within the images, and are generally defined differently for different indexing and search algorithms), which are then used to build an index or query resolution data structure that can subsequently be used to identify a ‘best match’ for a subsequent input image 908. Searching may generally proceed by performing the same form of feature extraction, whereby the resulting extracted features may be compared with the contents of the index or query resolution data structure in order to identify a viable matching object.

Returning to the specific example of barcode/QR code indexing and search in the flow diagram 900, a first step in both indexing and search is to identify the presence of a barcode or QR code within the input image 904, 908, as indicated by the block 912. If a barcode or QR code is identified, this can then be decoded 916. As is well-known, barcodes employ a number of standardized encodings, e.g., UPC-A, UPC-E, EAN-13, and EAN-8. All such barcodes can be decoded into a corresponding sequence of numbers and/or letters, which can then be used for indexing 920. Suitable text descriptions associated with products including barcodes may be obtained from the pages on which the images are found, and/or may be obtained or verified using any one of a number of publicly available barcode databases.

If a barcode is identified in an input image 908, and a matching barcode has been identified in a reference image, then an exact match will exist in the index. QR codes, similarly, are machine-readable with high reliability, and may contain up to 2953 bytes of data. While QR codes can be incorporated into the index 506, often their contents are descriptive and may include a URL. Accordingly, a QR code may itself contain a suitable text description, and/or may provide a URL from which a suitable text description can be directly extracted. This decision regarding the handling of QR codes, i.e. indexing or direct interpretation, is indicated at 924 of the flow diagram 900.

In any event, matching of a barcode with an index entry, and/or interpretation of a QR code, enables a text description result 928 to be returned. As noted above, barcodes and QR codes are designed to be machine readable, and to be relatively robust to variations in size and orientation, and libraries of existing code are available for identifying, reading and decoding all available barcode standards and QR codes. One such library is ZBar, which is an open-source software suite available for download, e.g. from http://zbar.sourceforge.net.

FIG. 10 is a flow diagram 1000 illustrating text/OCR indexing and search suitable for deployment in embodiments of the invention. Again, the algorithms employ common feature extractions 1004 and post-processing 1008 which are applied to reference images 904 as well as to input query images 908. In particular, a process 1004 is employed to identify text within images, using, e.g., optical character recognition (OCR) algorithms. Because OCR algorithms are orientation-specific, and text is often rotated within input images, the process 1004, according to embodiments of the invention, may apply the OCR algorithms to a number of rotations of the input images. Preferably, OCR is performed at least for the input orientation, as well as rotations of 90, 180 and 270 degrees. Additional rotation orientations may also be employed.

If text is identified and extracted, post-processing 1008 is performed. In particular, a number of checks are performed in order to confirm that the extracted text is valid, and to “normalize” the extracted text features. The text validation algorithm employs a number of rules to assign a rating to extracted text, which is used to assess the reliability and quality of the extracted text. These rules include the following:
it has been observed that reliable OCR text most commonly comprises a single line, and accordingly single-line text extraction is given an increased rating;
uncommon and/or non-English (or other supported language) characters are considered indicative of low-quality OCR, and result in a rating decrease;
ratings may also be reduced for non-alphabetic characters, which are generally less common in useful descriptive text; and
one or more dictionaries may be employed (e.g., the Enchant English Dictionary) to validate individual words, with the presence of valid dictionary words increasing the rating.

Dictionaries, and associated spellchecking algorithms, may be used to correct minor errors in OCR, e.g., when an extracted word is very close to a valid dictionary word. Words and phrases extracted by OCR from reference images 904 are incorporated into an index 1012. Text extracted from an input query image 908 can be compared with entries within the index 1012 as part of a search process. Errors and imperfections in OCR, as well as small variations in images, changes in orientation, and so forth, mean that (in contrast to barcodes and QR codes) an object which is indexed by associated OCR text may not be an exact match with text extracted from a corresponding query image input 908. Accordingly, a number of close matches may be identified, and ranked 1016. A ranking may be based upon an appropriate distance measure between text extracted from the input image 908 and similar words and phrases that have previously been indexed 1012. A closest-match may then be provided as a result 1020. Alternatively, if the ranking of extracted text and/or a closeness of match based on the distance measure fails to meet a predetermined threshold, the match may be rejected and an alternative recognition process employed.

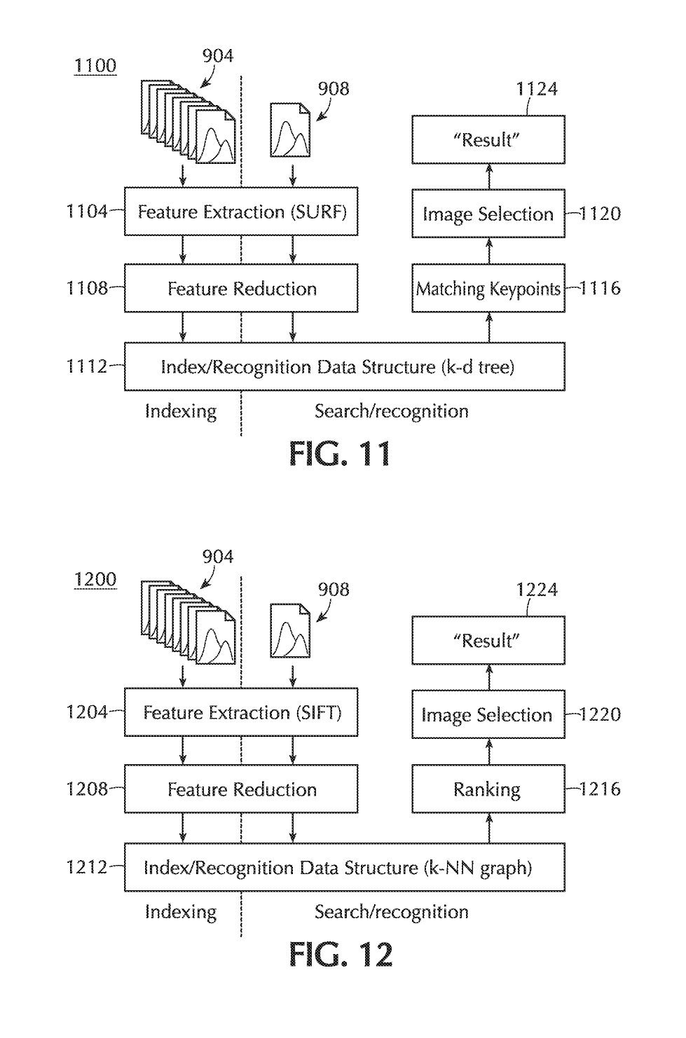

FIG. 11 is a flow diagram 1100 illustrating a movie poster indexing and search process that may be employed in embodiments of the invention. An exemplary implementation employs the SURF algorithm for feature extraction 1104. This algorithm is described in Herbert Bay et al., SURF Speeded Up Robust Features, 110 COMPUTER VISION & IMAGE UNDERSTANDING 346 (2008) (doi:10.1016/j.cviu.2007.09.014). Code libraries are available to implement this algorithm, including Open Source Computer Vision (OpenCV), available from http://opencv.org/.

A feature reduction process 1108 is employed to decrease memory usage and increase speed, whereby feature points extracted by the SURF algorithm 1104 are clustered and thinned within dense parts of the image. Following evaluation of performance of a number of sizes for the SURF feature vectors, a vector size of 128 has been chosen in an embodiment of the invention. At 1112, a k-dimensional (k-d) tree is employed as the image query resolution data structure for indexing the SURF feature vectors for movie poster images. The k-d tree is optimized to permit parallel searching over portions of the tree in order to identify feature sets associated with the reference images 904 that are most similar to the feature sets extracted from the input image 908. A set of closest matching key points 1116 is returned from the search algorithm, from which one “best match” is selected 1120. The text description associated with the corresponding image in a reference image database is then selected and returned 1124 as the result. Alternatively, if a closeness of match based on a key point similarity measure fails to meet a predetermined threshold, the match may be rejected and an alternative recognition process employed.

For images that are not identified as containing objects falling into a special category (e.g. barcodes/QR codes, identifiable text, movie posters, and/or any other specific categories for which algorithms are provided within an embodiment of the invention) a general analysis and object recognition algorithm may be applied, a flow diagram 1200 of which is illustrated in FIG. 12.

For general images, SIFT feature extraction 1204 may be employed, as described, e.g., in David G. Lowe, Distinctive Image Features from Scale-Invariant Keypoints, INT'L J. COMPUTER VISION, Nov. 2004, at 91 (doi:10.1023/B:VISI.0000029664.99615.94). The SIFT algorithm is also implemented by the OpenCV library, referenced above.

The SIFT algorithm is known to extract a large number of high-dimensional features from an image, with the consequence that the cost of running a search algorithm may be unacceptably high. A feature reduction process 1208 is therefore employed in an embodiment of the invention to provide feature filtering and sketch embedding, in order to overcome this problem.

A Locality Sensitive Hashing (LSH) method in combination with a k nearest neighbor (K-NN) may be employed to provide efficient approximate searching. In particular, LSH is employed for offline K-NN graph construction, by building an LSH index and then running a K-NN query for each object. In this case, the index 1212 and query resolution data structure together comprise the LSH index tables and the K-NN graph.

To further reduce the number of features (each of which comprises a 128-element vector in an embodiment of the invention) further filtering is performed in the feature reduction process 1208. For example, a feature that is repeated in many images within a relevant reference image database may not be a useful discriminating feature and thus may be ignored in the search algorithm. By analogy with non-discriminating words, such as “the” and “and”, within a text corpus, a Term Frequency-Inverse Document Frequency (TF-IDF) algorithm has been used to filter for the most useful features, and to reduce noise in the data set.

Further details of the K-NN graph construction and LSH indexing can be found in, e.g., Wei Dong et al., Efficient k Nearest Neighbor Graph Construction for Generic Similarity Measures, WWW '11: PROCEEDINGS OF THE 20TH INTERNATIONAL CONFERENCE ON WORLD WIDE WEB 577 (2011) (doi:10.1145/1963405.1963487).

A search within the index/graph 1212 results in a list of ranked similar images 1216 from which a selection 1220 is made. The description associated with the corresponding image within the reference image database is returned 1224 as the result. Alternatively, if a closeness of match based on the ranking fails to meet a predetermined threshold, the match may be rejected and an alternative recognition process employed.

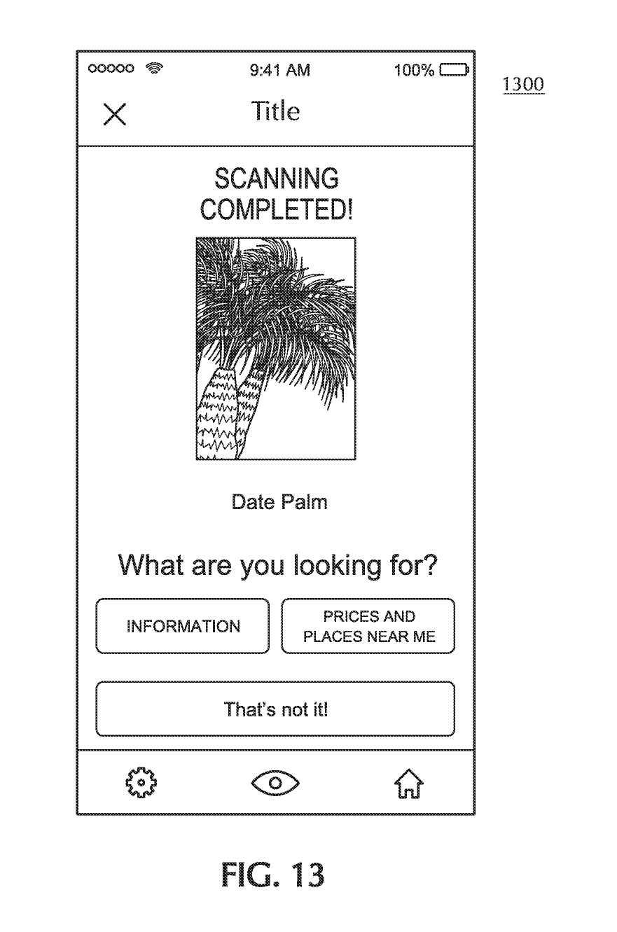

In an embodiment of the invention in which a server identifies the contents of the image, content identification (as in block 440 of FIG. 4) may then be completed with the server transmitting information identifying the contents to the handheld device, which receives the information. Block 450 of FIG. 4 then represents the handheld device's display of the result to the user. FIG. 13 depicts a user interface screen, according to an exemplary embodiment of the invention, that includes such a display of a result.

It will be appreciated that touchscreen-gesture-based demarcation of a region within an image displayed by a handheld device may have further applications. For example, according to an embodiment of the invention, an app on a handheld device may display, e.g., a map of an area, such as a street map. A user may then, e.g., with a finger gesture, trace a shape on the device's screen, delimiting a region of the map. In response, the app may, e.g., identify points of interest in the part of the area corresponding to the delimited region of the map and download and/or information pertaining to some or all of those points of interest.

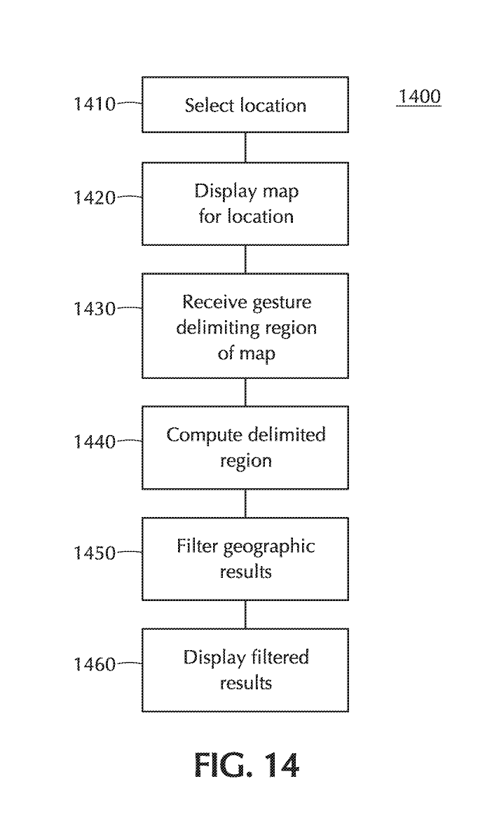

FIG. 14 depicts a flow 1400 of map filtering according to an embodiment of the invention. Map filtering may be used, for example, in connection with an app providing information about places of interest, such as stores, restaurants, historical sites, and/or any other feature that may interest a user of some kind in some context.

The flow 1400 begins in block 1410 with selection of a geographic area. The selection may be done automatically, e.g., through location services relying on cell tower triangulation, GPS facilities of the handheld device, and/or other methods. Instead of the foregoing, or in addition to it, the user may enter a location, for example, as an address, a zip code, a city, or a neighborhood, and the handheld device may, in response, transmit the entered data to, e.g., a server providing geolocation services in conjunction with a database of geocoded locations and/or other means.

In block 1420, the map is retrieved, e.g., from local storage or a remote server, and displayed on the screen of the handheld device. As displayed, the map may include a symbol (such as a dot) indicating the user's location relative to the map. In connection with an embodiment of the invention, the user may modify the display, e.g., by using one or more touchscreen gestures to scroll the displayed map and/or to change the scale of the map as displayed.

Block 1430 represents the user's delimiting a region of the map using a gesture, e.g., a pan gesture that traces a path on the map. In an embodiment of the invention, the user may provide other input first, e.g., by selecting a control with a touchscreen gesture to indicate that the user is going to delimit a region of interest with a second gesture. In block 1430, the user selects a region of the map, e.g., with a pan gesture as described; data capture from the gesture may proceed, e.g., as in the flow 600 that FIG. 6 depicts.

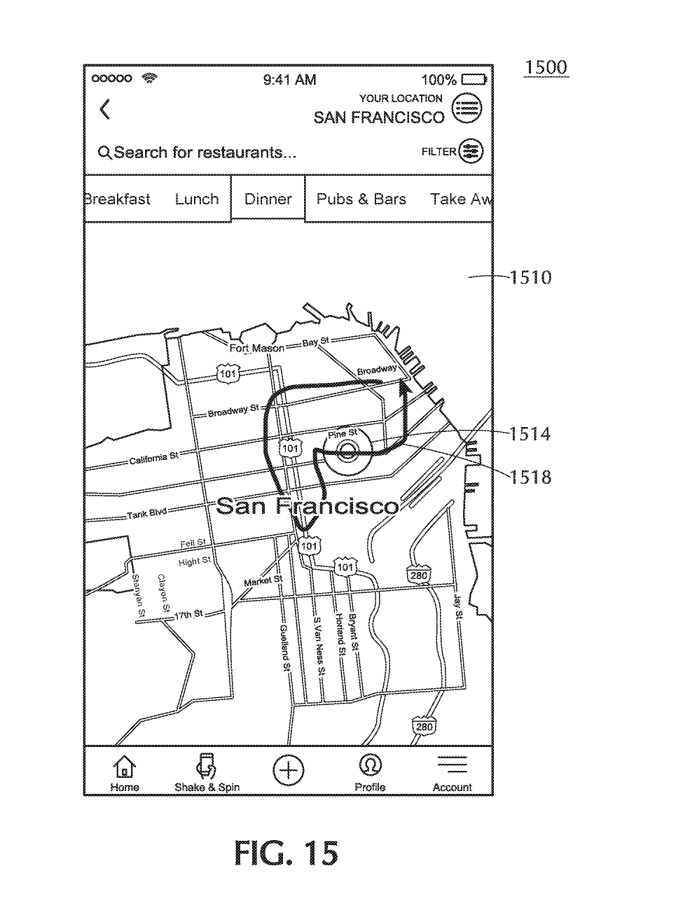

FIG. 15 depicts a user interface display 1500, according to an embodiment of the invention, reflecting the user's pan gesture. As depicted, the display 1500 includes a map 1510. As depicted, a dot 1514 is superimposed on the map 1510 to indicate, e.g., the current location of the device. As depicted also, a curved line 1518 is superimposed on the map, indicating, e.g., the path that the user's finger traced.

Returning to FIG. 14, in block 1440, a region of interest is computed to reflect the user's selection. For example, in an embodiment of the invention, an enclosing rectangle is computed, as described previously, and the region of interest is that enclosed by the rectangle. Alternatively, in an embodiment of the invention, the touchscreen gesture may be taken to define a simple polygon, which may be convex or concave, and the polygon may be taken to be the region of interest. It will be appreciated that the beginning and ending points of the path may not exactly coincide, so computing the polygon may include supplying a side that connects those beginning and ending points or otherwise closing the polygon.

Block 1450 represents creating a filtered set of information based on the geographic data and the selected region of interest. In embodiments of the invention, data and processing may involve the handheld device, one or more servers, or both. For example, in an embodiment of the invention, information about one or more points of interest within the mapped area may be stored, e.g., on the handheld device. The handheld device may then identify which of the points of interest, if any, are within the region of interest.

Alternatively, in an embodiment of the invention, the region of interest and/or data about the area corresponding to the displayed map may be transmitted to a server, which identifies points of interest within the region of interest, e.g., based on the data from the handheld device and a database of points of interest. The server may then transmit information related to one or more of the identified points of interest to the handheld device.

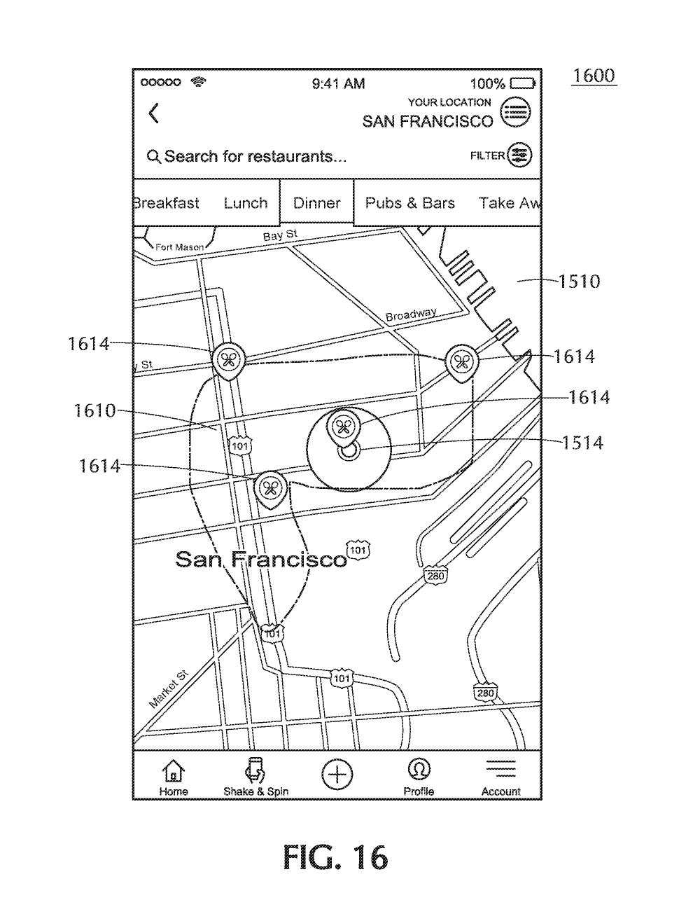

Once the region of interest has been computed, and before or after points of interest within the region of interest have been identified, software executing on the device (e.g., an app) according to an embodiment of the invention may update the screen display to indicate that region. FIG. 16 depicts such an updated display 1600 according to an embodiment of the invention. As before, the display 1600 includes a map 1510 and a dot 1514 that indicates the device's location within the mapped area. In an embodiment such as FIG. 16 depicts, the display 1600 may also indicate a region 1610, e.g., by shading (not pictured), which indicates the region of interest computed based on the gesture.

As depicted, the display 1600 may also include one or more symbols 1614 corresponding to one or more points of interest within the region of interest. In embodiments of the invention, different types of points of interest may be denoted by different symbols, e.g., a knife and fork may denote a restaurant, while a shopping cart depicts a retail location, etc.

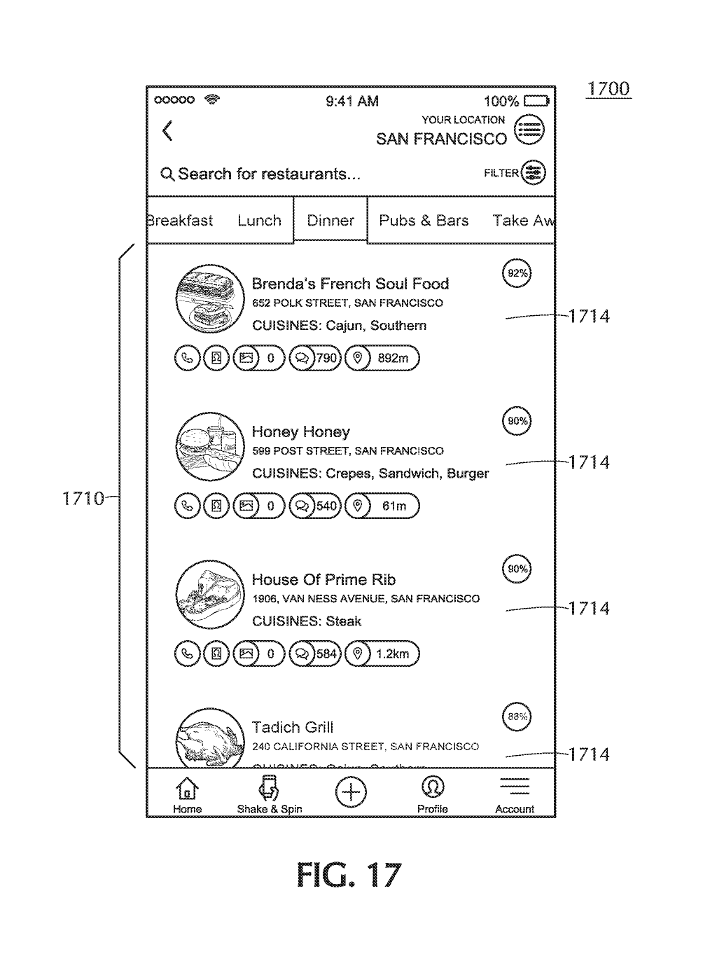

FIG. 17 depicts a user interface display 1700 that includes an alternative view of the filtered information according to an embodiment of the invention. As depicted, the display 1700 includes a scrollable list 1710 of entries 1714. Each entry 1714 in turn provides information about one or more places of interest within the selected region of interest. For example, an entry 1714 such as FIG. 17 depicts might, for a restaurant, give the restaurant's name and address, information about the types of food served, the distance from the device to the restaurant, links to reviews, etc. It will be appreciated that other kinds of information may be provided as appropriate for other kinds of places of interest.

It will be appreciated that portable devices, including but not limited to smartphones and other handheld devices, are beginning to supplement or replace touchscreen input and output with other modalities. Embodiments of the invention may support selection of areas of interest using these modalities, singly or in combination with other modalities, in ways that may be analogous to selection via touchscreen gestures.

For example, “augmented reality” has been used to refer to a view of the user's environment that computer-generated perceptual information may be superimposed upon. According to embodiments of the invention, a region of interest, analogous, e.g., to those defined by touchscreen gestures, may be defined using augmented reality technology, e.g., as disclosed in the text below and the accompanying drawings. The view may include identification points, some inside the region of interest and some outside of it; according to embodiments of the invention, one or more entities may be automatically identified based on some or all of the identification points within the region of interest.

An augmented reality system may be configured to be able to superimpose images on one or more parts of a user's field of vision, and “view” may be used here to refer to those parts. For example, as described below, augmented reality glasses may include a projection unit configured to project images onto all or part of a lens or visor that spans all or part of a user's field of vision. “View” in this context may refer to that part of the lens on which the projecting system can project images. (It will be appreciated that the augmented reality glasses may acquire the contents of the view through one or more cameras that are positioned to cover some or all of the field of view that the user can see directly.)

As another example, an augmented reality application on a smartphone may acquire images through a smartphone camera and display those images, with added information and/or imagery, on part or all of the smartphone's screen; in that case, “view” may refer to that part of the screen.

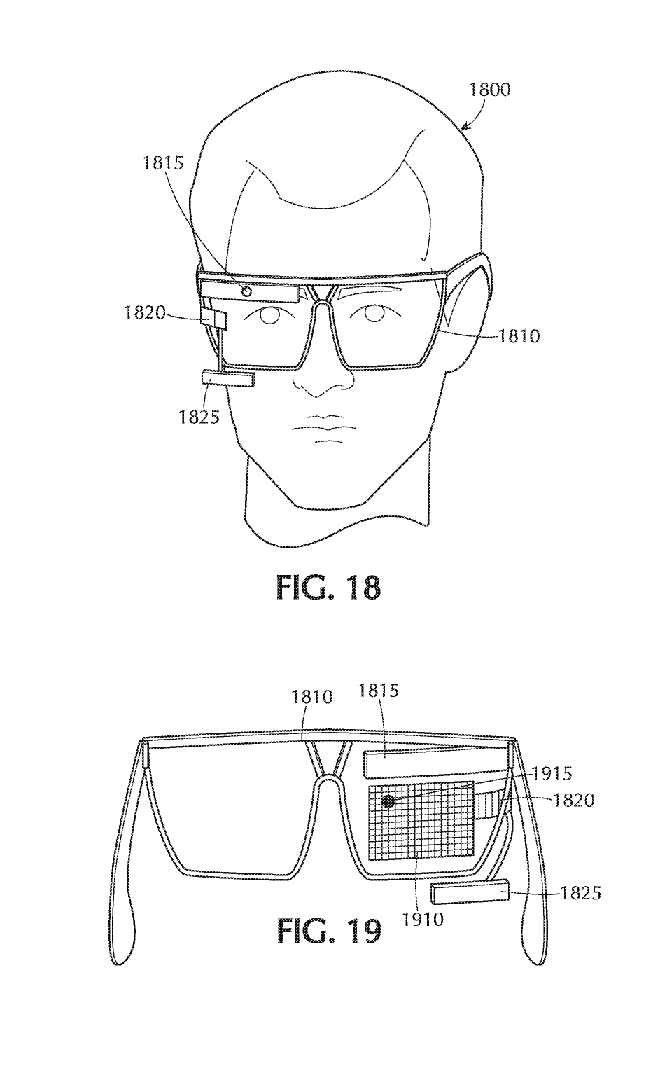

The drawings illustrate alternative methods of defining a region of interest based upon augmented reality (“AR”) technology. For example, as FIG. 18 depicts, in an embodiment of the invention, a user 1800 wears a pair of AR glasses 1810. The AR glasses 1810 in an embodiment such as the depicted one may include, e.g., a front-facing camera 1815 and a projector 1820 that enables additional information and imagery to be superimposed onto the field of vision of the user 1800. An eye-tracking system 1825 may include, e.g., a rear-facing camera (not pictured) that can be used to track the motion of the user's eyes, and to determine a current direction of the user's gaze.

When using AR glasses, a user may be said to be looking at objects directly, in the sense that the user is looking at the objects themselves (even if through, e.g., a lens or visor) and not at images of the objects presented on a display device.

Products implementing some or all of a front-facing camera 1815, a projector 1820, and an eye-tracking system 1825 may include, e.g., Glass Enterprise Edition from X Technology, LLC (http://www.x.company/glass/), Pupil hardware and software from Pupil Labs GmbH (https://pupil-labs.com/pupil/), SMI eye tracking systems from SensoMotoric Instruments GmbH (https://www.smivision.com/), and Tobii eye tracking technology from Tobii AB (https://www.tobii.com/tech/). This list is not limiting, however, and embodiments of the invention may exist in connection with any products, systems, or both, that suitably provide these functions.

In an embodiment of the invention, the AR glasses 1810 may, e.g., include their own processor and memory, and they may execute a full operating system and applications independently of other devices or may be connected to a separate processing device, such as a smartphone, via a wired or wireless connection (e.g., Bluetooth).

FIG. 19 illustrates how AR glasses 1810 may enable the user 1800 to define a region of interest according to embodiments of the invention. As depicted, the projector 1820 may project, e.g., a grid 1910 is such a way that it is superimposed on the user's field of vision. As the user's direction of gaze is tracked via the tracking system 1825, a corresponding gaze position indicator 1915 may also be projected onto the user's field of vision.

Embodiments of the invention may allow users to activate region-of-interest input in one or more ways. For example, activation in connection with embodiments of the invention may be based upon biometric indicators known to be associated with attention and interest. Such indicators include, e.g., gaze fixation properties (e.g. duration of gaze, start and end pupil sizes, and end state such as saccade or blink) and gaze fixation count. Detection of one or more such indicators may be integrated, e.g., into functioning provided by one or more of the systems described previously.

(Consistent with the use of the term in the art, the tracked actions of the eye and/or motion of the gaze point may be referred to as “eye gestures” and are analogous to the touchscreen gestures described previously.)

Instead of the foregoing, or in addition to it, activation input according to embodiments of the invention may be received, e.g., from a button (not pictured) located on the glasses 1810, an IR-sensor (not pictured), or from vocal input via a microphone (not pictured) located on the glasses 1810 or a connected processing device (not pictured); it may be based upon detection of body gestures within the field of the camera 1820; or may be a proximity-based input.

In the case of a vocal input, a voice recognition facility may be built into the AR glasses 1810, a connected processing device, or both, and may recognize, e.g., commands or other vocal input. For example, the user may in an embodiment of the invention speak activation words (such as “start” and “stop”) at the beginning and end of a path traced out via gaze direction, and optionally tracked by the gaze position indicator 1915. Alternatively, in an embodiment of the invention, where a grid 1910 is projected onto the user's field of vision, it may be labeled with a coordinate system (e.g., alphabetical letters on one axis, and numbers on the other) such that the user can identify a region of interest by pointing to the area within the visual field, or speaking the coordinates of relevant defining points, such as diagonally-opposing corners of a bounding rectangle.

In sum, in connection with embodiments of the invention, an area of the visual field that is of interest, and/or an object or a part of an object within the user's field of vision may be determined, e.g., by using determined gaze point and/or an activation input (e.g., a button press, a touchscreen gesture, an eye gesture, voice, or a human body gesture such as is described below). On receipt of a previously defined activation input, a system within the AR glasses 1810 or in communication with it may designate an area, object, or object part to be of interest based, e.g., on one or more eye gestures and/or the activation input. The precise effect may vary depending on the embodiment of the invention, but a specific contextual action may be determined based on the received activation input and the designated area, object, or object part of interest. For example, one such specific contextual action that may be executed is the selection of the region of interest, e.g., for some further operation.

According to embodiments of the invention, for example, such a further operation may be identification of one or more objects within the region, and this identification may proceed analogously to identifying objects within a region designated with a touchscreen gesture, e.g., as described above.

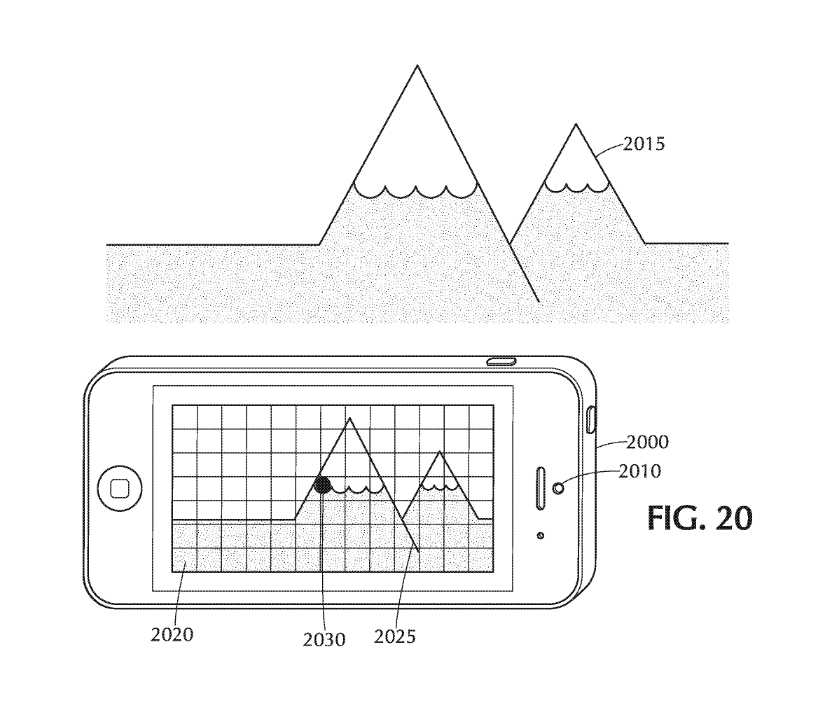

FIG. 20 depicts, according to an embodiment of the invention, a smartphone 2000 executing an application that supports forms of AR input—including, e.g., gaze input—as an example of how such functions may be implemented in a handheld device. Such devices may have multiple cameras, including at least one rear camera (not pictured), and a front camera 2010. The rear camera can be used to capture real-time images of a scene 2015, and the device may display them on the screen 2020. A grid 2025 may be superimposed on the images.

In embodiments of the invention, the user's direction of gaze may be determined, e.g., by processing real-time images of the user's eye captured by the front camera 2010 simultaneously with capture of the images by the rear camera. Software to carry out this processing is known to the art and commercially available: for example, Pupil Labs GmbH, mentioned previously, provides a software package called “Pupil Capture” in both binary and source-code forms. The detected direction of gaze may then be used to superimpose a gaze position indicator 2030 onto the displayed images. The user may then provide activation inputs in a similar manner to the head-mounted AR system 1810 (FIG. 18).

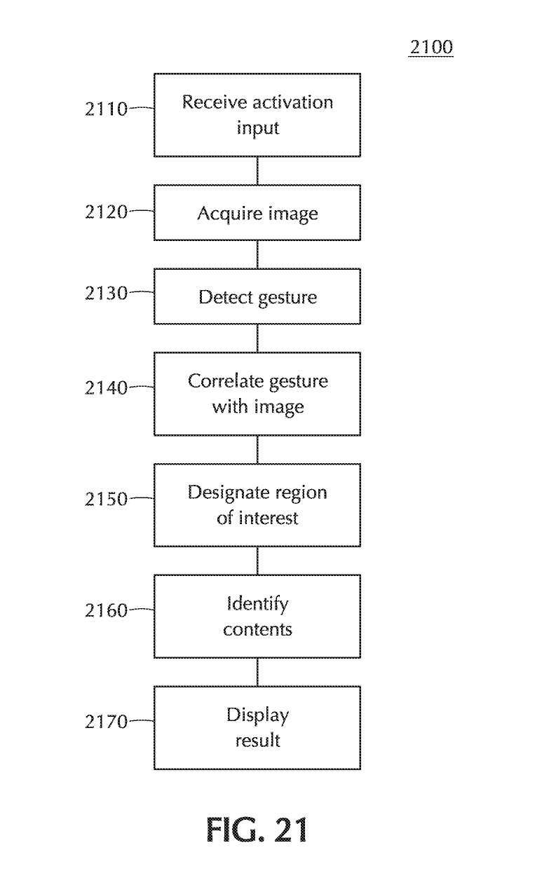

FIG. 21 depicts a flow 2100 of object isolation and recognition with augmented reality, according to an embodiment of the invention. It will be appreciated that the depicted flow 2100 is similar to the flow 400 that FIG. 4 depicts.

The flow 2100 in FIG. 21 begins with the AR system receiving 2110 activation input. As already described, this input may take many forms, including (but not limited to) tracked gestures, voice commands, and activation of a button or other input device.

The AR system acquires an image corresponding to the view in block 2120. AR glasses, in an embodiment of the invention, may acquire the image through a camera aimed towards what the user is seeing. In embodiments of the invention, the AR system has been calibrated to allow the AR system to correlate areas of the acquired image with corresponding areas of the user's field of view.

Image acquisition 2120 need not occur after the AR system receives 2110 activation input but may occur beforehand. In embodiments of the invention, the AR system may automatically acquire images at short intervals, updating the AR system effectively in real time.

In block 2130, according to an embodiment of the invention, the system may detect the user's eye gesture, e.g., as described above. In block 2140, the system in embodiments of the invention correlates the location of the gesture with the acquired image and then designates 2150 a region of interest of the image. In embodiments of the invention, the view may reflect the gesture, the region of interest, or both; for example, a projector 1820 (FIG. 18) may project an image onto the visor or lens, thereby superimposing that image onto the view. Further, if the AR system is updating the image in real-time and correlating that image with the view, the projected image may move as the user's head moves, e.g., to keep the indication of the region of interest aligned with the same content of the view.

According to embodiments of the invention, a region of interest may be designated, e.g., to improve identification of the contents of the image. In block 2160 of FIG. 21, the AR system may cause identification of the contents of the region of interest, e.g., as in block 440 of FIG. 4. The result or results of the identification may be displayed, e.g., by a projector 1820 (FIG. 18), in block 2170 (FIG. 21).

Object identification according to embodiments of the invention such as FIG. 21 depicts has been described in connection with identifying objects that the user perceives through the lens or visor. It will be appreciated, however, that similar designation and identification can take place in connection with an image displayed by the projector 1820 (FIG. 18) on the lens or visor. For example, a map (not pictured) may be projected, and one or more eye gestures may designate a region of interest of the map.

Besides eye gestures, other types of gestures may be used to designate regions of interest according to embodiments of the invention. For example, U.S. Patent Application Publication 2014/0225918 by Mittal et al., titled “Human-Body-Gesture-Based Region and Volume Selection for HMD”, discusses using gestures such as hand gestures to designate a region of interest and thereby select an augmented reality object on a head-mounted display. (Following Mittal, such gestures may be referred to here as “human body gestures”.) A human body gesture may be indicated by the position and/or movement of either or both hands, and such a gesture may in an embodiment of the invention designate a region of interest within the user's view. In an embodiment of the invention, one or more identification points may be found within a digital image corresponding to the view, within a region of interest of the image that corresponds to the selected region of interest. As with regions of interest designated, e.g., in other ways described in this disclosure, automated identification of one or more entities may follow designation of a region of interest though a human body gesture.

Forms of gaze, gesture, and voice-based activation, in connection with embodiments of the invention, need not be limited to real-time AR systems. To the contrary, in connection with embodiments of the invention, these input modalities may also be used in conjunction with, e.g., other displayed data and images on devices that have the capability to track eye movement, human body gestures within a visual field, and/or receive audio input, either using built-in sensors or additional peripheral devices. Applicable systems and devices can include personal digital assistants, portable music players, laptop computers, computer gaming systems, e-books, and computer-based “intelligent environments” where, for example, objects presented on multiple displays can be selected and activated.

The invention has been illustrated in terms of certain exemplary embodiments. Those embodiments are not limiting, however; variations upon the disclosed embodiments will be apparent to those skilled in the relevant arts and are within the scope of the invention, which is limited only by the claims.

I claim:

1. A method of improving content identification using a portable device comprising one or more processors, a memory coupled to at least one of the processors, and a touchscreen comprising a display and coupled to one or more of the processors, the portable device being configured to communicate via one or more data networks, the method comprising:
storing in the memory first data comprising a photograph depicting one or more objects, the photograph comprising a plurality of identification points, and each depicted object being associated respectively with one or more of the identification points;
displaying at a first time a first portion of the photograph on the display, the first portion consisting of some or all of the photograph, all of the first portion being displayed on the display at the first time, and none of the photograph other than the first portion being displayed on the display at the first time;
while displaying all of the first portion of the photograph on the display and not displaying on the display any of the photograph other than the first portion, accepting user input through the touchscreen to produce second data, the second data delimiting a region of the photograph, a first plurality of the identification points being in the region and a second plurality of the identification points being outside of the region, the user input consisting of one or more touchscreen gestures, and the region delimited by the second data being entirely contained within the first portion and not coextensive with the first portion;
at a second time subsequent to the first time and subsequent to producing the second data, displaying on the display all of the first portion of the photograph and superimposed thereon a visual indication, relative to the first portion, of the user input or the region delimited by the second data, none of the photograph other than the first portion being displayed on the display at the second time;
automatically identifying one of the objects based on the first plurality of the identification points, the identification comprising algorithmically associating a plurality of the first plurality of the identification points with the identified object; and
at a third time subsequent to the second time, displaying on the display information related to the identified object;
wherein:
the region has a shape, and
the mobile device comprises programming that determines the shape prior to accepting the user input but does not determine proportions of the shape.

2. The method of claim 1, comprising displaying on the display at the third time the region of the photograph delimited by the second data.

3. The method of claim 1, wherein automatically identifying the one of the objects based on the first plurality of the identification points comprises automatically identifying a set of identification points based on the first data and the second data, the set of identification points comprising all of the first plurality of the identification points and excluding all of the second plurality the identification points.

4. The method of claim 1, wherein automatically identifying one of the objects based on the first plurality of the identification points comprises:
computing third data based on the first data and the second data;
transmitting the third data to the server via the network; and
receiving information, from the server via the network, that identifies the one of the objects.

5. (canceled)

6. The method of claim 1, wherein:
the user input consists of exactly one single-touch gesture; and
automatically identifying one of the objects based on the first plurality of the identification points occurs immediately consequent to completion of the exactly one single-touch gesture.

7. The method of claim 1, wherein:
the user input consists of exactly one single-touch gesture; and
automatically identifying one of the objects based on the first plurality of the identification points occurs immediately consequent to completion of exactly one additional touchscreen gesture performed immediately subsequent to the exactly one single-touch gesture.

8. The method of claim 1, wherein the user input consists of exactly one touchscreen gesture by which the user draws one or more lines on the image.

9. The method of claim 8, wherein the shape is a closed polygon.

10. The method of claim 9, wherein:
the closed polygon is a rectangle;
the rectangle has two vertical edges; and
no rectangle smaller than the rectangle encloses all of the one or more lines.

11. (canceled)

12. The method of claim 10, wherein the displaying of the information on the device's display related to the identified object comprises displaying information that identifies the object.

13-29. (canceled)
